(19) United States
(12) Patent Application Publication
(10) Pub. No.: US 2010/0255361 A1
(43) Pub. Date: Oct. 7, 2010

(54) Connecting Structure for Exteriorly Connecting Battery Cells

(76) Inventor: Donald P.H. Wu, Hsinchu County (TW)

Correspondence Address: Dr. BANGER SHIA;Patent Office of Bang Shia, 102 Lindencrest Ct., Sugar Land, TX, 77479-5201, US

(21) Appl. No.: 12/510,996

(22) Filed: Jul. 28, 2009

Related U.S. Application Data
(63) Continuation-in-part of application No. 12/418,596, filed on Apr. 5, 2009, now abandoned.

(51) Int. Cl. H01M 2/20

(52) U.S. Cl. 429/121

(57) ABSTRACT

A connecting structure for exteriorly connecting battery cells comprises at least one connecting graphite alloy block serving as a bridge for electrical connection between two battery cells in series or parallel configuration. The connecting graphite alloy block is directly connected to nickel-metal or nickel-plated electrode terminals of the battery cells in a close contact manner to realize a connection with high electric conductivity among the cells without utilization of conventional welding procedures. The connecting graphite alloy block is less expensive and less sensitive to oxidation; whereas, the connecting graphite alloy block and the positive as well as negative electrode terminals of the battery cells both being made of the nickel-plated metal will dissolve into each other while in mutual contact forming a carbon-nickel miscible alloy, thus ensuring a smooth large-current discharge because of the reduction in resistance of external connection.

This application is a continuation of part of U.S. patent application Ser. No. 12/418,596, which claims the benefit of the earlier filing date of Apr. 05, 2009. Claims 1 of this application is revised from the previous claim 1 of the U.S. patent application Ser. No. 12/418,596, Claims 2-3 of this application correspond to the previous claims 5-6 of the U.S. patent application Ser. No. 12/418,596, Claim 4 of this application is revised from the previous claim 2 of the U.S. patent application Ser. No. 12/418,596, and Claim 5 of this application is new.

### BACKGROUND OF THE INVENTION

1. Field of the Invention

The present invention relates to a connecting structure for exteriorly connecting battery cells which is weldless and resistant to oxidation and can provide a high conductivity connection among many battery cells.

2. Description of the Prior Art

The existing high power battery assemblies are mainly constructed by connecting multiple battery cells in series, parallel or series-parallel through connecting sheets. The positive and the negative electrode terminals of the respective battery cells are normally made of the nickel or nickel-plated metal, and so are the connecting sheets because of the advantage that nickel is resistant to oxidation and hence more secure for long services. As for the battery cells 11 in a conventional battery assembly, as shown in FIGS. 1 and 2, no matter in serial or parallel configuration, they are all connected by a connecting sheet 10 welded to the metallic electrode terminals 12 of the battery cells 11 through several welding spots 13 which could reduce the external contact resistance of the battery assembly.

It is to be noted that, the above connecting technology for conventional battery cell can electrically connect two battery cells through nickel connecting sheets by spot welding; but, it suffers from many disadvantages such as:

1. After being used for a long time, the nickel connecting sheets will still be eventually oxidized or contaminated with foreign matters, thus increasing the electric resistance of the connecting sheets.

2. The nickel connecting sheets are connected to the electrode terminals of the battery cells through the welding spots typically in small contact areas, resulting in high contact resistance, thus causing increase in temperature of the electrode terminals of the battery cells as well as the welding spots plus extra power losses of the battery cells during the recharging or discharging processes.

3. The nickel connecting sheets are expensive; and, the welding process is time-consuming and labor intensive, making the conventional battery connecting technology uneconomic.

Hereafter, the present invention has arisen to mitigate and/or obviate the afore-described disadvantages.

### SUMMARY OF THE INVENTION

The primary objective of the present invention is to provide a connecting structure for exteriorly connecting battery cells in accordance with the present invention mainly utilizes at least one connecting graphite alloy block serving as a bridge for connecting two battery cells in series or parallel. In the present invention, the connecting graphite alloy block is connected to the electrode terminals of the battery cells in a direct contact manner to realize a highly conductive connection without utilization of the conventional welding procedures. Furthermore, the connecting graphite alloy block is less-expensive compared to nickel so that the production cost can be greatly reduced.

The secondary objective of the present invention is to provide a connecting structure for exteriorly connecting battery cells which mainly utilizes a connecting graphite alloy block to electrically connect two battery cells in series or parallel. The connecting graphite alloy block by itself is resistant to oxidation. After close mutual contact, the connecting graphite alloy block and the positive, the negative electrode terminals of the battery cells will start a process of dissolving in each other, namely the process of carbon particles of the connecting graphite alloy block substituting for the foreign matters on the surfaces of the negative and the positive electrode terminals of the battery cells so as to fill the voids in the metallic surfaces of the negative and the positive electrode terminals of the battery cells until forming a carbon-nickel miscible alloy, thus ensuring a smooth large-current discharge due to reduction of the external connection resistance.

In order to achieve the above objectives, a connecting structure for exteriorly connecting battery cells in series in accordance with the present invention comprises: a first battery cell which is exteriorly provided with a positive electrode terminal and a negative electrode terminal both made of nickel-plated metal and served as power output terminals of the first battery cell; at least one connecting graphite alloy block which is made of a graphite alloy selected from a group consisting of silver graphite, copper graphite, and silver-copper graphite and connected to the positive electrode terminal of the first battery cell; and a second battery cell which is exteriorly provided with a positive electrode terminal and a negative electrode terminal both made of nickel-plated metal and served as power output terminals of the second battery cell. The negative electrode terminal of the second battery cell is connected to the connecting graphite alloy block so as to connect the first battery cell and the second battery cell in series.

Furthermore, a connecting structure for exteriorly connecting battery cells in parallel comprises: a first battery cell which is exteriorly provided with a positive electrode terminal and a negative electrode terminal both made of nickel-plated metal and served as power output terminals of the first battery cell; at least one first connecting graphite block which is made of a graphite alloy selected from a group consisting of silver graphite, copper graphite, and silver-copper graphite and connected to the positive electrode terminal of the first battery cell; a second battery cell which is exteriorly provided with a positive electrode terminal and a negative electrode terminal both made of nickel-plated metal and served as power output terminals of the second battery cell, the positive electrode terminal of the second battery cell is connected to the first connecting graphite block; and at least one second connecting graphite block which is made of a graphite alloy selected from a group consisting of silver graphite, copper graphite, and silver-copper graphite and connected to the negative electrode terminal of the first battery cell and the negative electrode terminal of the second battery cell so as to connect the first and the second battery cells in parallel.

### BRIEF DESCRIPTION OF THE DRAWINGS

FIG. 1 is a partial perspective view of a conventional battery assembly which is constructed by connecting battery cells in series through a nickel sheet;

FIG. 2 is a structural view of another conventional battery assembly which is constructed by connecting battery cells in parallel through a nickel sheet;

FIG. 3 is a schematic view of a connecting structure for exteriorly connecting battery cells in series by connecting graphite alloy block;

FIG. 4 is a schematic view of a connecting structure for exteriorly connecting battery cells in parallel by connecting graphite alloy block;

FIG. 5-1 shows the respective electrode terminals of the battery cell being contaminated with foreign matters on a surface thereof in accordance with the present invention;

FIG. 5-2 shows the foreign matter being replaced by carbon particles after the connecting graphite alloy block in contact with the surface of the electrode terminal in accordance with present invention;

FIG. 6 is a side view showing that how the battery cells are connected in series-parallel by the connecting graphite alloy block in accordance with the present invention to construct a battery assembly; and

FIG. 7 is a side view showing that two coffee-bagged battery cells made of aluminum foil are connected in series by the connecting structure in accordance with the present invention.

### DETAILED DESCRIPTION OF THE PREFERRED EMBODIMENTS

The present invention will be easily comprehended from the following description when viewed together with the accompanying drawings, which show, for purpose of illustrations only, the preferred embodiment in accordance with the present invention.

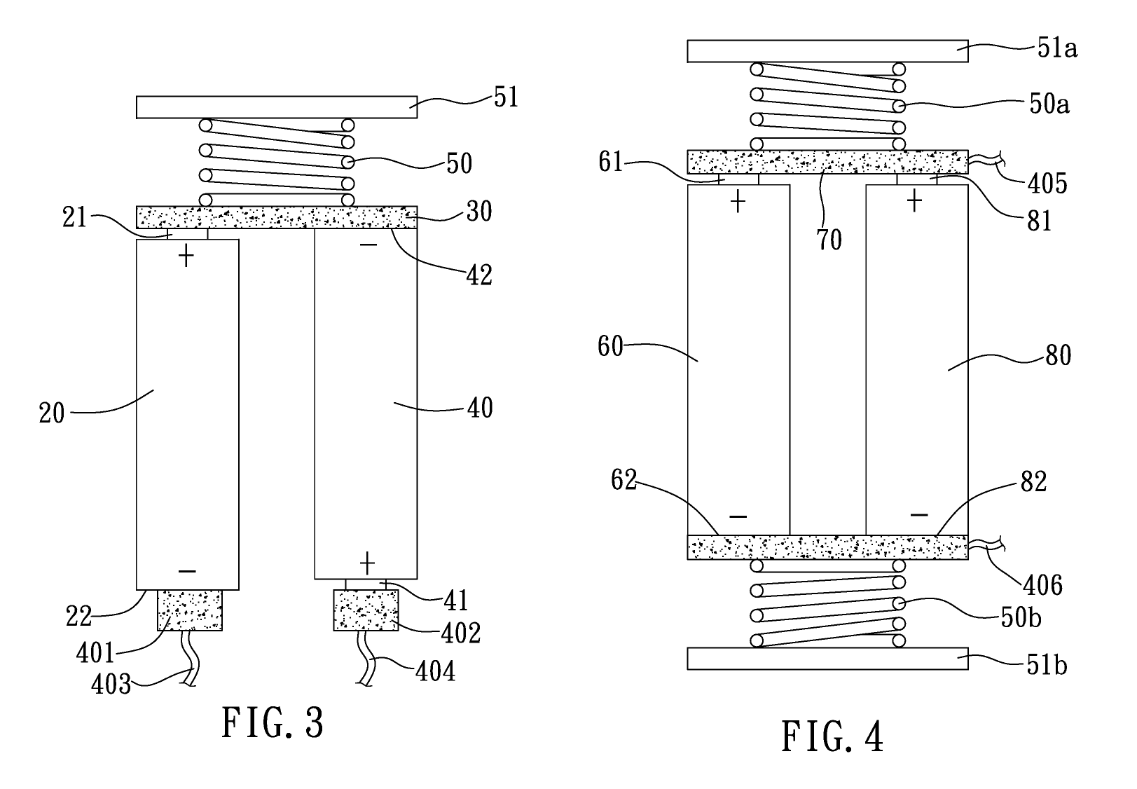

Referring to FIG. 3, when two battery cells are connected in series, between a first and a second battery cell 20, 40 is connected at least one connecting graphite alloy block to improve the electric conductivity between the first and the second battery cells 20, 40.

The first battery cell 20 is a cylindrical battery cell and exteriorly provided on both ends thereof with a positive electrode terminal 21 and a negative electrode terminal 22 both being made of nickel-plated metal and served as power output terminals of the first battery cell 20.

The connecting graphite alloy block 30 is made of a graphite alloy selected from a group consisting of silver graphite (silver-carbon alloy), copper graphite (copper-carbon alloy), and silver-copper graphite (silver-copper-carbon alloy). The connecting graphite alloy block 30 is electrically connected to the positive electrode terminal 21 of the first battery cell 20 in a close contact manner.

The second battery cell 40 is exteriorly provided on both ends thereof with a positive electrode terminal 41 and a negative electrode terminal 42 both being made of nickel-plated metal and served as power output terminals of the second battery cell 40. The negative electrode terminal 42 of the second battery cell 40 is electrically connected to the connecting graphite alloy block 30 in a close contact manner. A spring 50 and a supporting plate 51 are employed to push against the connecting graphite alloy block 30 in close contact with the first and the second battery cells 20, 40. Thereby, the first and the second battery cells 20, 40 are connected in series.

In addition, the negative electrode terminal 22 of the first battery cell 20 and the positive electrode terminal 41 of the second battery cell 40 each can be connected to a graphite terminal 401, 402 as a final power output terminal thereof. Each of the graphite terminals 401, 402 is interiorly provided with a wire 403, 404 serving as a power output wire thereof.

Further referring to FIG. 4, when two battery cells are connected in parallel, a first connecting graphite alloy block and a second connecting graphite alloy block are employed for making electrical connection between the first battery cell and the second battery cell in parallel in order to improve the electric conductivity between the first and the second battery cells.

The first battery cell 60 is a cylindrical battery cell and exteriorly provided on both ends thereof with a positive electrode terminal 61 and a negative electrode terminal 62 both being made of nickel-plated metal and served as power output terminals of the first battery cell 60.

The first connecting graphite alloy block 70 is made of a graphite alloy selected from a group consisting of silver graphite (silver-carbon alloy), copper graphite (copper-carbon alloy), and silver-copper graphite (silver-copper-carbon alloy). The first connecting graphite alloy block 70 is electrically connected to the positive electrode terminal 61 of the first battery cell 60 in a close contact manner.

The second battery cell 80 is a cylindrical battery cell and exteriorly provided on both ends thereof with a positive electrode terminal 81 and a negative electrode terminal 82 both being made of nickel-plated metal and served as power output terminals of the second battery cell 80. The positive electrode terminal 81 of the second battery cell 80 is electrically connected to the first connecting graphite alloy block 70 in a close contact manner.

The second connecting graphite alloy block 90 is made of a graphite alloy selected from a group consisting of silver graphite (silver-carbon alloy), copper graphite (copper-carbon alloy), and silver-copper graphite (silver-copper-carbon alloy. The second connecting graphite alloy block 90 is connected to the negative electrode terminal 62 of the first battery cell 60 and the negative electrode terminal 82 of the second battery cell 80. Two sets of springs 50a, 50b and supporting plates 51a, 51b are employed for pushing against the first and the second connecting graphite alloy blocks 70, 90, respectively in order to tightly contact the first and the second battery cells 60, 80. Thereby, the first and the second battery cells 60, 80 are connected in parallel.

In addition, the first and the second connecting graphite alloy blocks 70, 90 each are interiorly provided with a wire 405, 406 serving as a power output wire thereof.

The aforementioned is the summary of the positional and structural relationship of the respective components of the preferred embodiment in accordance with the present invention.

As for the function of the present invention, the present invention mainly utilizes connecting graphite alloy blocks to directly connect the battery cells in series or parallel without utilization of the conventional welding procedures, thus improving the connective conductivity and reducing the production costs because of elimination of the conventional welding procedure.

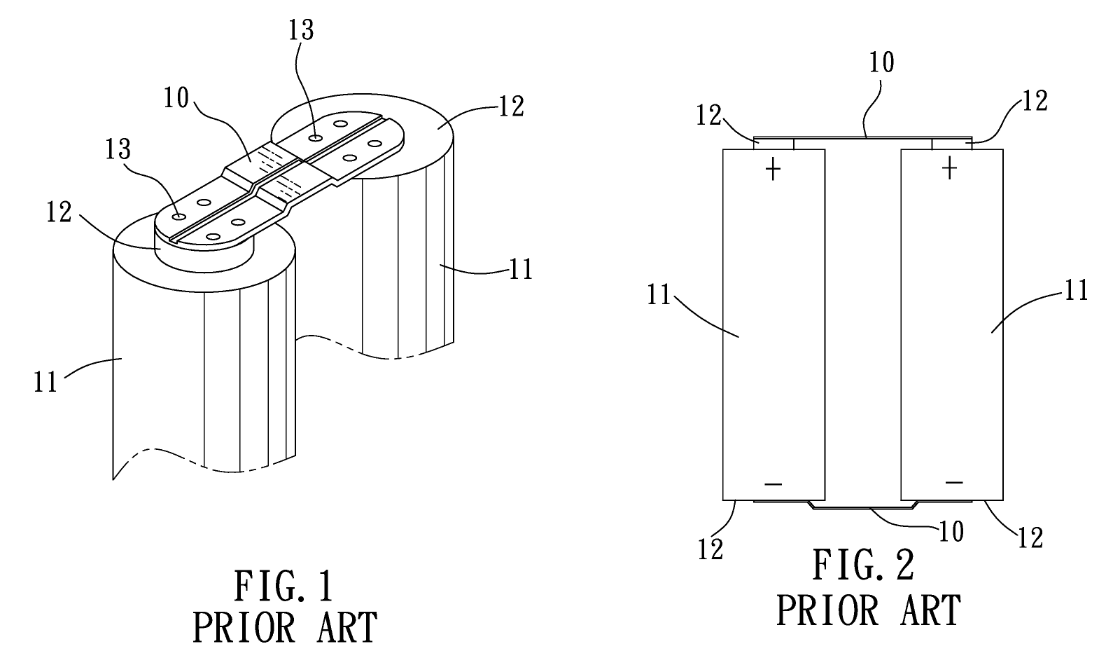

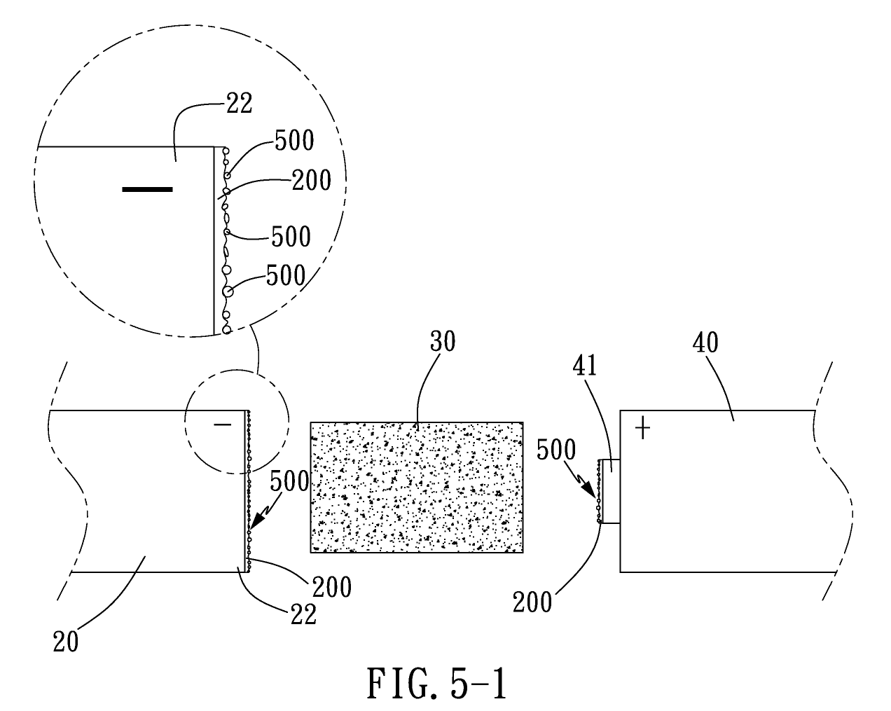

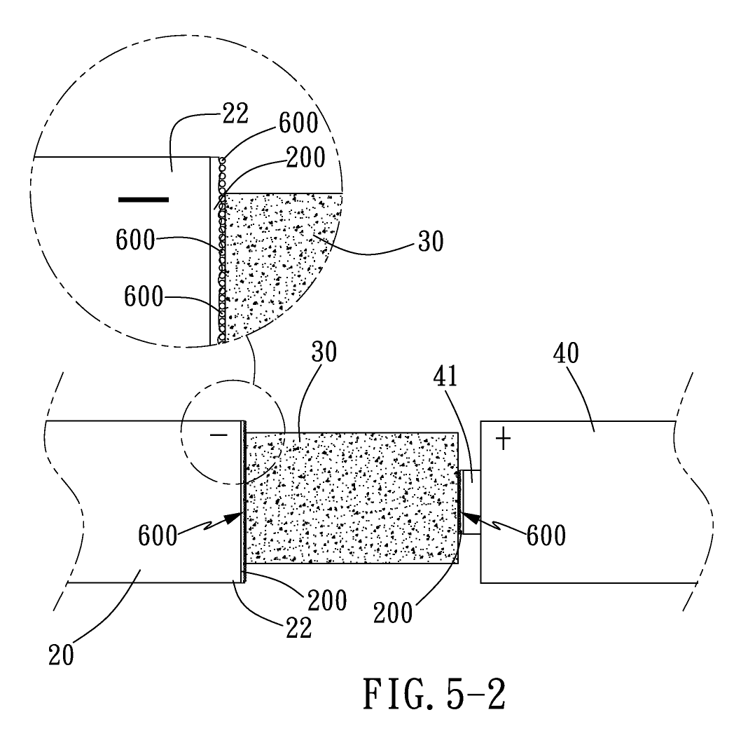

It is to be noted that, referring to FIG. 5-1, the negative electrode terminal 22 and the positive electrode terminal 41 of the first and the second battery cells 20, 40 are both made of the nickel-plated metal, the positive and the negative electrode terminals 41, 22 each are adhered with foreign matters 500 or oxides 200 on a surface thereof, the foreign matters 500 or oxides 200 will increase the connection resistance during the discharging process of the first and the second battery cells 20, 40 while reducing the discharging power efficiency of the battery cells. Referring to FIG. 3 and FIG. 5-2, showing how to realize high conductivity connection between battery cells, the connecting graphite alloy block 30 is electrically connected to the positive and the negative electrode terminals 41, 22 of the first and the second battery cells 20, 40; the connecting graphite alloy block 30 by itself is resistant to oxidation, and the connecting graphite alloy block 30, and the positive, the negative electrode terminals 41, 22 of the first and the second battery cells 20, 40 will dissolve into each other after mutual contact, that is, the carbon particles 600 of the connecting graphite alloy block 30 will substitute for the foreign matters 500 or oxides 200 on the positive and the negative electrode terminals 41, 22 made of the nickel-plated metal to fill in the voids in the positive and the negative electrode terminals 41, 22, and then form a carbon-nickel miscible alloy, thereby improving the connective conductivity among the connecting graphite alloy block 30, the first battery cell 20 and the second battery cell 40. In other words, after the battery assembly in accordance with the present invention is switched on, electric current will flow between the first battery cell 20, the connecting graphite alloy block 30 and the second battery cell 40 smoothly through the connecting structure for exteriorly connecting battery cells of the present invention without being affected by the inherent resistance caused by the oxides 200 or the foreign matters 500, thus not only reducing the external connection resistance between the first and the second battery cells 20, 40, but facilitating the successful discharging of the first and the second battery cells 20, 40.

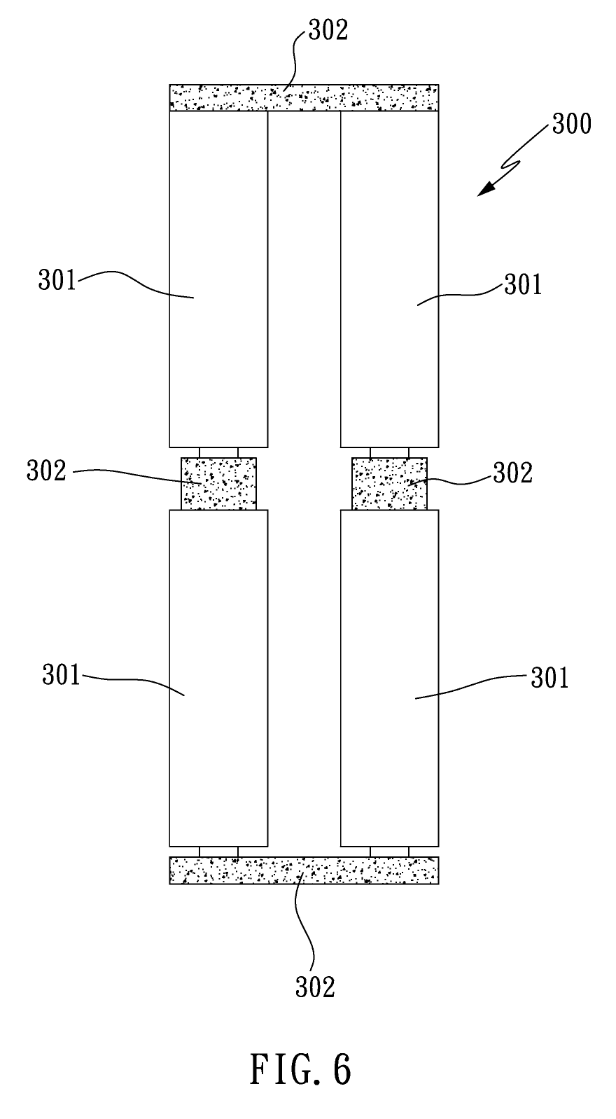

Referring to FIG. 6, when plural battery cells 301 are connected in series, parallel or series-parallel to construct a high-power battery assembly 300 through plural connecting graphite alloy blocks 302 of the present invention, since the connecting graphite alloy blocks 302 will dissolve into the positive and the negative electrode terminals both being made of nickel-plated metal to improve the connective conductivity between the respective battery cells 301, the power loss of the external resistance of the battery assembly 300 is comparably less than that of the conventional battery assembly in which the battery cells are connected through nickel sheets by spot welding. Evidently, the external resistance of the battery assembly which is constructed by making use of the connecting technology of present invention is relatively small, and the contact resistance of the battery cells 301 and the connecting graphite alloy blocks 302 is reduced which resulting in reduction of working temperature. In other words, the discharging losses of the battery assembly which is constructed by making use of the technology of the present invention are reduced, and the power of the battery assembly can be delivered smoothly in high efficiency.

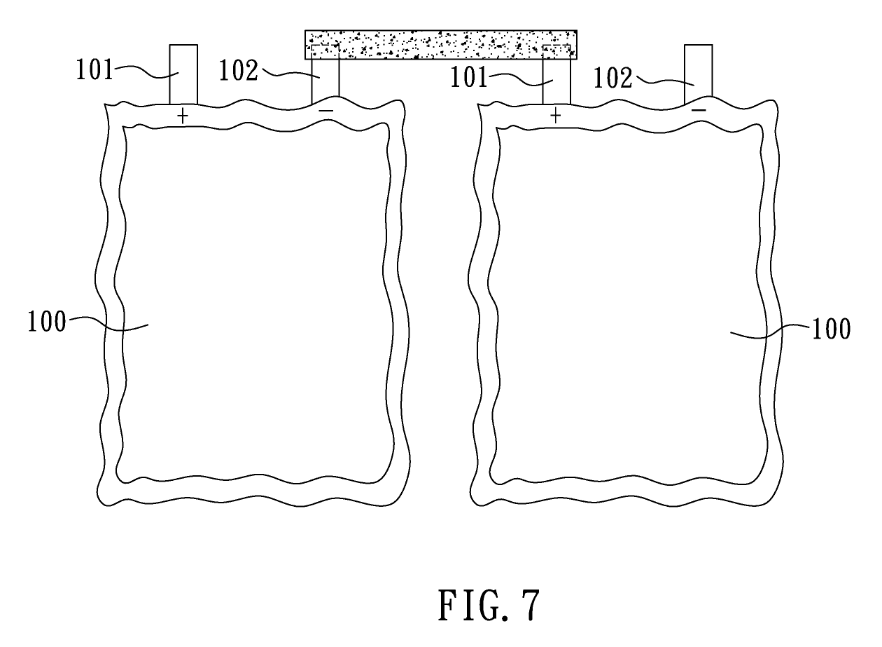

In addition to the cylindrical metal-cased battery cells, as shown in FIG. 7, the present invention is also applicable to coffee-bagged battery cells in aluminum foils. The positive and the negative electrodes of the coffee-bagged battery cells are normally stamp-formed into electrode tabs made of nickel-plated metal, as shown in FIG. 7. When two coffee-bagged battery cells 101, 102 are connected in series, a connecting graphite alloy block 30 is employed to electrically connect the positive and the negative electrode tabs 105, 106 of the two battery cells 101, 102, respectively. It is to be noted that, the metal-cased battery cells are only different in shape to the coffee-bagged battery cells, that is, they are indifferent in electrical connection effects. In other words, the technology of the present invention is independent to the internal configuration of the battery cells as long as the positive and the negative electrode terminals of the battery cells are made of the nickel-plated metal, hence, the battery cells can be connected through the connecting graphite alloy blocks of the present invention to realize the high conductivity external connection of the battery cells.

While we have shown and described various embodiments in accordance with the present invention, it is comprehensive to those skilled in the art that further embodiments may be made without departing from the scope of the present invention.

What is claimed is:

1. A connecting structure for exteriorly connecting battery cells in series comprising:
a first battery cell being exteriorly provided with a positive electrode terminal and a negative electrode terminal both being made of nickel-plated metal and served as power output terminals of the first battery cell;
at least one connecting graphite alloy block being made of a graphite alloy selected from a group consisting of silver graphite, copper graphite, and silver-copper graphite and connected to the positive electrode terminal of the first battery cell; and
a second battery cell being exteriorly provided with a positive electrode terminal and a negative electrode terminal both being made of nickel-plated metal and served as power output terminals of the second battery cell, the negative electrode terminal of the second battery cell being connected to the connecting graphite alloy block so as to connect the first battery cell and the second battery cell in series.

2. The connecting structure for exteriorly connecting battery cells in series as claimed in claim 1, wherein a spring and a supporting plate are employed to push against the connecting graphite alloy block in close contact with the first and the second battery cells.

3. The connecting structure for exteriorly connecting battery cells in series as claimed in claim 1, wherein the negative electrode terminal of the first battery cell and the positive electrode terminal of the second battery cell each are connected to a graphite terminal as a final power output terminal thereof, the graphite terminals each are interiorly provided with a wire serving as a power output wire thereof.

4. A connecting structure for exteriorly connecting battery cells in parallel comprising:
a first battery cell being exteriorly provided with a positive electrode terminal and a negative electrode terminal both being made of nickel-plated metal and served as power output terminals of the first battery cell;
at least one first connecting graphite block being made of a graphite alloy selected from a group consisting of silver graphite, copper graphite, and silver-copper graphite and connected to the positive electrode terminal of the first battery cell;
a second battery cell being exteriorly provided with a positive electrode terminal and a negative electrode terminal both being made of nickel-plated metal and served as power output terminals of the second battery cell, the positive electrode terminal of the second battery cell being connected to the first connecting graphite block; and
at least one second connecting graphite block being made of a graphite alloy selected from a group consisting of silver graphite, copper graphite, and silver-copper graphite and being connected to the negative electrode terminal of the first battery cell and the negative electrode terminal of the second battery cell so as to connect the first and the second battery cells in parallel.

5. The connecting structure for exteriorly connecting battery cells in parallel as claimed in claim 4, wherein two sets of springs and supporting plates are employed for pushing against the first and the second connecting graphite alloy blocks, respectively in order to tightly contact the first and the second battery cells.
